(19) United States
(12) Patent Application Publication
(10) Pub. No.: US 2015/0047135 A1
(43) Pub. Date: Feb. 19, 2015

(54) Oscillating scrubbing device

(71) Applicants: Luz Patricia Cerda, Palmetto Bay, FL (US); Helmuth H. Montoya, I, Palmetto Bay, FL (US); Kay Lichtenstein, Palmetto Bay, FL (US)

(72) Inventors: Luz Patricia Cerda, Palmetto Bay, FL (US); Helmuth H. Montoya, I, Palmetto Bay, FL (US); Kay Lichtenstein, Palmetto Bay, FL (US)

(21) Appl. No.: 13/987,622

(22) Filed: Aug. 16, 2013

(51) Int. Cl. A61C 17/26

(52) U.S. Cl. CPC A61C 17/26
USPC 15/28

(57) ABSTRACT

The inventive concept is directed to a device used for scrubbing or polishing items. The device is contained in a housing that contains a mechanism for creating an oscillating motion. A scrubbing or polishing pad is attached to a circular disc which is driven in an oscillating manner by said mechanism. The circular disc is mounted on a support plate which is attached at bottom of said housing in a laterally pointing position. Said support plate is mounted to said housing at an obtuse angle relative to said housing. This enables an operator of said device to obtain a clear view of the ongoing procedure.

### BACKGROUND OF THE INVENTION

The inventive concept is directed to an oscillating scrubbing or polishing device. Prior and known devices, like mentioned above, do exist. Most of them are in a cylinder form having a bottom disc driven by a central motor located in the cylinder and the bottom disc may be oscillating or always just rotating. The oscillating mechanism may be mechanical or the bottom disc may be driven by an AC motor that have means incorporated therein to cause the motor to oscillate.

### BRIEF DESCRIPTION OF THE INVENTION

The present Invention has an oscillating mechanism that is driven by a DC motor which can be recharged by an electric charger incorporated in the device. There is a housing that includes the DC motor, the recharger and the mechanism that induces an oscillation. The difference in the construction of this device is that that the scrubbing pad is located on the bottom of the device but laterally removed there from. At the bottom of the housing there is located a rotary disc which is supported by a disc support plate which is located laterally from the housing so that the operation of the scrubbing or polishing disc can be observed while in action. This is quite an advantage over prior art devices. The flat scrubbing pad can be replaced by a pointed scrubbing element which can be used to clean corners of a pot or pan or clean crevasses. The lateral support plate is mounted on the bottom of the housing at an obtuse angle so that the housing which serves as a handle does not obstruct the view while the device is in operation.

### BRIEF DESCRIPTION OF THE DRAWINGS

FIG. 1 illustrates the device with a housing having a scrubbing disc at the bottom.

FIG. 2 is the illustration of FIG. 1 having a pointed scrubbing element located thereon.

FIG. 3 shows the oscillating mechanism with the motor driving shaft in line with the driven shaft of the scrubbing disc.

FIG. 4 shows the oscillating mechanism of FIG. 3 with the above noted driving shafts offset from each other.

### DETAILED DESCRIPTION OF THE INVENTION

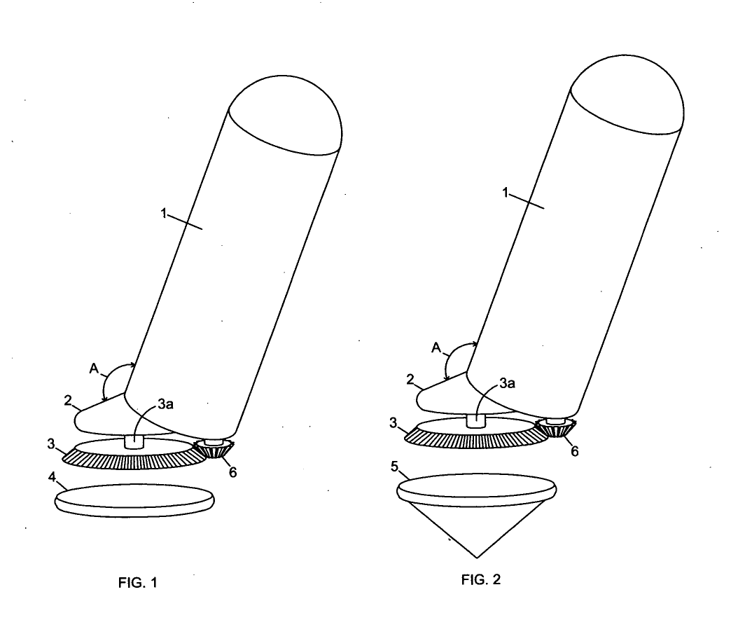

FIG. 1 illustrates the scrubbing device having a top cylinder 1 which also severs as the handle of the device. At the bottom of the handle there is mounted or attached a lateral support plate 2 which is mounted to the handle 1 at an obtuse angle shown at A. This mounting affords the operator of the device to observe the scrubbing motion of the scrubbing 4 because the handle 1 does not block this view. The scrubbing disc 4 is mounted on the oscillating disc 3 which is mounted to the support plate 2 by way of a shaft 3a. The oscillating disc 3 is driven by a first bevel gear 6 which driven by the oscillating mechanism on the inside of the handle 1.

FIG. 2 presents the same view as was explained with regard to FIG. 1. The difference in this view is the fact that the circular scrubbing disc 4 is replaced by a pointed scrubbing element 5. As explained, the pointed scrubbing element is useful in tight corners, grooves or other locations that are not easily accessible to a flat disc.

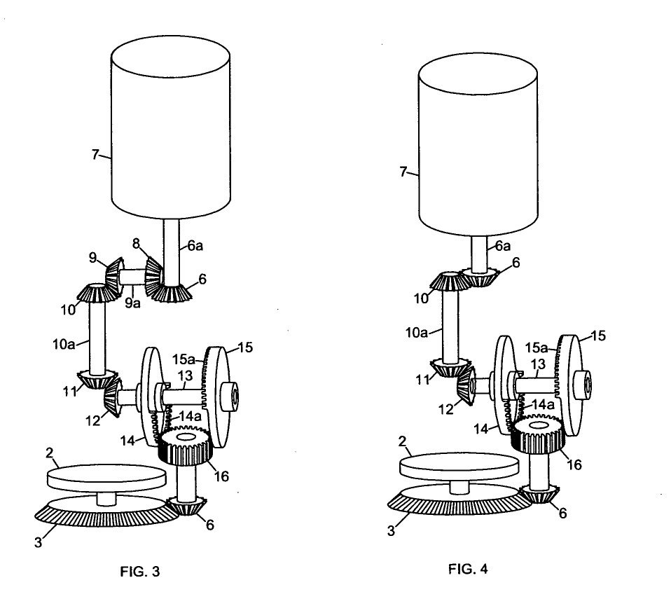

FIG. 3 represents the oscillating mechanism which is entirely located in the housing 1. There is shown the electric motor 7 which is preferably a low voltage DC motor that can easily be recharged. The recharger is not shown in this Fig. because it is such a well known item where ever electric tools are being used. The electric motor 7 drives a second bevel gear 6 by way of the shaft 6a. The second bevel gear 6 drives another bevel gear 8 at a right angle and drives the shaft 9a to drive another bevel gear 9 which in turn drives another bevel gear 10, again at a right angle which now drives the shaft 10a which will drive the bevel gear 11. Bevel gear 11 drives another bevel gear 12 at a right angle. Bevel gear 11 drives the bevel gear 12 which in turn drives the shaft 13. The main oscillating system is mounted on shaft 13 which has two circular discs 14 and 15 mounted thereon. The circular discs 14 and 15 have gear teeth located thereon in only half circles 14a and 15a. The two half circles 14a and 15a are located on their respective discs in opposite directions to each other. Between the two circular discs 14 and 15 is located a circular gear wheel 16 which in turn will drive the first bevel gear 6 shown in FIGS. 1 and 2. In operation, when the shaft 13 is driven from the electric motor 7 by their respective gears 6, 8, 10. 11 and 12, the two circular discs 14 and 15 are driven in the same rotation. When the half circle gear 14 encounters the circular gear 16 with its gear teeth 14a it will drive this gear in one direction. Then, while there is void of teeth on disc 14, the circular disc 15 with its half circle of gear teeth will encounter the gear wheel 16 and drive the same in the opposite direction. This then will create the oscillating motion of the oscillating disc 3 and assure an oscillating motion of the scrubbing or polishing pad 3 or the pointed element 5 when in use. It should be noted that the gearing represented in this FIG. 3 assures that second driving shaft 6a of the motor 7 is somewhat axially aligned with the drive shaft from the circular gear 16 which drives the circular disc 3.

In FIG. 4 the basic oscillating principle is used except that the drive shaft 6a with the bevel gears 8 and 9 has been eliminated. However, there is no axial alignment between the second motor drive shaft 6a and the lower drive shaft from the circular gear 16. This might result in that the housing 1 may have to be somewhat enlarged.

The oscillating mechanism with its respective motor 7 can easily be incorporated in the cylindrical housing 7 due to the well known criteria of miniaturization.

It also foreseen that an electric DC motor could be used which is so designed to oscillate on its own. This way the complicated oscillating mechanism could be replaced.

What is claimed is:

1. A scrubbing or polishing device which is laterally attached to a housing, said housing having contained therein a mechanism for creating an oscillating motion to a scrubbing pad attached to a driven disc driven by said oscillating motion, which driven disc is mounted to a support plate attached laterally to a bottom of said housing at an obtuse angle relative to said housing.

2. The scrubbing or polishing device of claim 1, wherein said scrubbing pad is replaced by a pointed scrubbing pad.
